(19) United States
(12) Patent Application Publication
(10) Pub. No.: US 2012/0041130 A1
(43) Pub. Date: Feb. 16, 2012

(54) CROSSLINKABLE RUBBER COMPOSITION, THE USE THEREOF, THE RUBBER GRAINS THEREFROM, AND A METHOD FOR PREPARING AND INJECTION MOLDING THE RUBBER GRAINS

(75) Inventor: Sunyong Ye, Zhejiang Province (CN)

(73) Assignee: SHANGHAI DRB&TAFU INDUSTRY CO., SHANGHAI (CN)

(21) Appl. No.: 13/255,872

(22) PCT Filed: Jul. 30, 2009
(86) PCT No.: PCT/CN2009/000850

§ 371 Date: Nov. 3, 2011

(30) Foreign Application Priority Data
Mar. 10, 2009 (CN) 200910047435.0
Jun. 26, 2009 (CN) 200910150291.1

(51) Int. Cl. C08L 9/06; B29C 45/72; B29B 9/02

(52) U.S. Cl. 524/524; 264/141; 525/232; 264/328.14; 525/222; 525/237; 524/525; 524/526

(57) ABSTRACT

The present invention relates to a crosslinkable rubber composition, the use thereof, the rubber grains formed therefrom, and a method for preparing and injection molding the rubber grains. The crosslinkable rubber composition includes at least a styrene butadiene copolymer, a softener for rubber, a flow modifier and a peroxide vulcanizing agent. The crosslinkable rubber composition is suitable for being made into rubber products. It can be made into rubber grains that will not crosslink below a temperature of 80° C. The rubber grains are formed through internal mixing, open mixing and pelleting extrusion. The rubber composition and the rubber grains of the present invention can be formed directly by injection molding and kept at room temperature over a long period of time.

### BACKGROUND OF THE INVENTION

1. Field of the Invention

The present invention, belonging to the rubber manufacturing technical field, relates to a rubber composition, and particularly to a vulcanizable rubber composition that can be kept at room temperature over a long period of time as well as the rubber grains formed therefrom.

2. Description of the Related Technology

Rubber is an important macromolecular elastomer material and considerably used in various products, such as tires, shoe soles, seal rings, and various protection devices. The materials used for various products are required to be good in abrasion resistance, flex resistance, water/oil resistance, and heat/cold resistance, high in flexibility and tear strength, and also low in the cost, with a complicated forming process. Various rubber products are mainly made from combination of the following various rubber materials: Natural rubber, isoprene rubber, butadiene rubber, styrene butadiene rubber, nitrile butadiene rubber, neoprene rubber, ethylene propylene terpolymer rubber, and so on. Various traditional rubber materials, being high in molecular weight and poor in fluidity, can be formed only by compression molding. Besides, steam heating is adopted in the vulcanized process of rubber for improving uniformity of the mold temperature; however, this process requires a complicated and expensive high pressure boiler, which is high in equipment investment and energy consumption. The traditional rubber has a high molecular weight and a high level of entanglement among the molecules thereof, which makes the rubber generate a great deal of heat in the process of open mixing or internal mixing; because this heat is not easily dissipated, the stock is inclined to be vulcanized partly, thus producing defects in rubber products formed by compression molding. Moreover, the stock that is vulcanized with the traditional sulphur may be self-vulcanized at a slightly higher environmental temperature, and thus cannot be stored over a long period of time; a low temperature environment is needed if a long-term storage is desired. Defective rubber and thermoplastic elastomers are produced as a result of these various shortcomings, particularly the use of styrene series of elastomer. The styrene series of elastomer can be formed by injection molding through a simple manufacturing and recovery process; however, since the styrene series of elastomer keeps the mechanical properties only through physical junctions, it cannot satisfy the requirements of some products for high performance (such as high abrasion resistance, or high tear strength). Furthermore, the styrene series of thermoplastic elastomer is very difficult to produce effective chemical crosslinking because the styrene series of thermoplastic elastomer is a block copolymer of various segments with different difficulty levels of crosslinking, which makes crosslinking nonuniform.

### SUMMARY OF THE INVENTION

To address the various shortcomings of the existing rubber materials and their corresponding manufacturing processes, the present invention is directed to a novel crosslinkable rubber composition, the use thereof, the rubber grains formed therefrom, a method for preparing and injection molding the rubber grains, and a method for directly forming the rubber composition and the rubber grains by injection molding; besides, the rubber grains will not be self-vulcanized at a temperature below 80° C., and can be kept at a temperature of 30° C.°C. over a long period of time, having no need for low-temperature storage.

The following technical solution is adopted to achieve the purpose of the present invention and to solve the technical problems to be solved therein. A crosslinkable rubber composition presented according to the present invention comprises the following components: 40-70 phr of styrene butadiene copolymers, 10-30 phr of flow modifiers, 10-50 phr of softening oil, and 0.1-1 phr of vulcanizing agents.

In another embodiment, the crosslinkable rubber composition as described above further contains 1-30 phr of reclaimed materials.

The following technical means can also be adopted to further achieve the purpose of the present invention and solve the technical problems to be solved therein.

In the rubber composition as described above, with or without the reclaimed materials, the styrene butadiene copolymer has a linear or multiple-arm star-shaped molecular structure, the molecular chain structure being a completely atactic copolymer structure of styrenic monomers and diene monomers or an alternating micro-block structure formed by the multiple block copolymerization of styrenic monomers and diene monomers, content of the 1,2-structure in the diene structure being 10-40%; the molecular structural formula of the styrene butadiene copolymer is —(PS_{X}—PB_{Y})ₙ— or (—(PS_{X}—PB_{Y})ₙ)_{M}R, with the former being of a linear structure while the latter of a multiple-arm star-shaped structure, where PS is a styrenic polymer, PB a diene polymer, R the “core” of the star-shaped structure, X a positive integer in the range of 1-300, Y a positive integer in the range of 1-2000, n a positive integer in the range of 10-3000, and M a positive integer in the range of 3-20; the weight percent content of the styrenic monomer in this styrene butadiene copolymer is 5-80%, with molecular weight of the copolymer being 40000-500000 Da.

In the rubber composition as described above, with or without the reclaimed materials, the flow modifier thereof can be selected from at least one of styrene-butadiene-styrene copolymer, styrene-ethylene-butene-styrene copolymer and styrene-ethylene-propylene-styrene copolymer.

In the rubber composition as described above, with or without the reclaimed materials, the reclaimed materials thereof can be selected from at least one of reclaimed rubber, PE reclaimed materials, EVA reclaimed materials, PP reclaimed materials and combinations thereof.

In the rubber composition as described above, with or without the reclaimed materials, the softening oil thereof can be selected from at least one of naphthenic oil, alkane oil, aromatic hydrocarbon oil and combinations thereof.

In the rubber composition as described above, with or without the reclaimed materials, the vulcanizing agent thereof can be selected from at least one of benzoyl peroxide, bis(para-benzoyl peroxide), di-tert-butyl peroxide, dicumyl peroxide and cumene hydroperoxide and combinations thereof.

A rubber composition as described above, with or without the reclaimed materials, further includes a processing assistant, which is selected from one or more of the following groups consisting of a vulcanization accelerator, an aging inhibitor, a mold releasing agent, a reinforcing agent, a flame retardant, a thickening agent, a detackifier and combinations thereof.

The present invention provides a rubber product, which includes the rubber composition as described above.

The present invention further provides a crosslinkable rubber grain, which is made of the rubber composition as described above.

The rubber grains as described above are suitable for injection molding or extrusion molding. These rubber grains will not crosslink at a temperature below 80° C.

The process for preparing the crosslinkable rubber grains as described above can be selected from the following three processes:

A first process for preparing the rubber grains involves first simultaneously adding and mixing the styrene butadiene copolymer, the flow modifier, the reclaimed material and the softening oil in a predetermined ratio are in an internal mixer to be internally mixed for 10-30 minutes. Then the vulcanizing agent is added and mixed for 3-10 minutes at a temperature of 60-120° C. to form a stock. The stock after internal mixing is mixed in an open mixer. The stock is tight-milled 2-20 times before being rolled and sheeted. Finally the stock is extruded and pelletized by an extruder at a temperature of 60-110° C., and then goes through air circulation cutting or water circulation cutting to form the grains.

A second process for preparing the rubber grains involves first the flow modifier and the softening oil in a predetermined ratio are placed and mixed in an internal mixer to be internally mixed for 5-15 minutes. Then the styrene butadiene copolymer and the reclaimed material are added and mixed for 5-15 minutes. The vulcanizing agent is added and mixed for 3-10 minutes, with the temperature of the internal mixer being 60-120° C. The stock formed after internal mixing is mixed in the open mixer. The stock is then tight-milled 2-20 times before being rolled and sheeted. Finally the stock is extruded and pelletized by an extruder at a temperature of 60-110° C., and then goes through air circulation cutting or water circulation cutting to form the grains.

A third process for preparing the rubber grains involves first simultaneously adding and mixing the styrene butadiene copolymer, the flow modifier, the reclaimed material and the softening oil in a predetermined ratio in an internal mixer to be internally mixed for 8-30 minutes, with the temperature of the internal mixer being 100-160° C.; Then the stock formed after internal mixing is sheeted and the vulcanizing agent is added to the sheeted stock. The stock is then tight-milled 10-30 times before being rolled and sheeted. Finally the stock is extruded and pelletized by an extruder at a temperature of 60-110° C., and then goes through air circulation cutting or water circulation cutting to form the grains.

In the preparation process, various processing assistants can be added as required to produce different products, such as a reaction promoter, a vulcanization accelerator, a vulcanization promotion assistant, an antioxidant, an anti-ultraviolet agent, a foaming agent, an aging inhibitor, a heat stabilizer, a light stabilizer, an ozone stabilizer, a processing aid, a plasticizer, a thickening agent, a blowing agent, dye, pigment, wax, an extender, an organic acid, a polymerization inhibitor, a metal oxide, and an activator such as triethanolamine, polyglycol, hexanetriol and so on, which are known in rubber industry. These rubber assistants are used at a normal dosage, which is especially dependent on the expected use. The normal dosage is for example 0.1 wt % to 50 wt % as required by rubber.

The present invention further provides a molded rubber product, which is made of the rubber grains as described above by injection molding.

The molded rubber product as described above is made by means of the injection molding method.

The molded rubber product as described above is a shoe sole.

By adopting the technical solution as described above, the present invention has at least the following advantages and beneficial effects:

1. The rubber composition and rubber grains according to the present invention use the styrene butadiene copolymer whose molecular chain structure is composed of mixed atactic and block segments. Since this copolymer has a low molecular weight, the material has desirable fluidity; in addition, with the partial block structure, the material can still have good mechanical properties at a low molecular weight; furthermore, the micro-block structure will not affect the vulcanization uniformity and can be used to produce a material having good mechanical properties even with minimum vulcanizing agent, therefore the semi-vulcanized material is easily desulfurized and recovered.

2. The rubber composition and rubber grains according to the present invention use a peroxide vulcanizing agent, which allows vulcanization at a later stage, easily controllable vulcanization rate and uniform vulcanization. The advantages also include that the rubber grains will not be self-vulcanized at a temperature below 140° C., and can be kept at room temperature over a long period of time, having no need for low-temperature storage.

3. The rubber composition and rubber grains according to the present invention may include a reclaimed material, which can effectively lower manufacturing costs. Moreover, the reclaimed material, being semi-desulfurized, exists in the form of tiny rubber grains after being mixed with the rubber, which can effectively intensify and increase the flexibility of the rubber.

The above description is only a summary of the technical solution of the present invention. Detailed description will be given in the following with reference to preferred embodiments and drawings so as to further clarify the technical means of the present invention to and to clarify the purposes, features and advantages of the present invention as described above and elsewhere in the application.

### DETAILED DESCRIPTION OF THE PREFERRED EMBODIMENT(S)

For further description of the technical means adopted in the present invention for achieving the intended purpose of the present invention as well as the effects, the crosslinkable rubber composition presented in the present invention, the use thereof, the rubber grains therefrom, and the method for preparing and injection molding the rubber grains will be described in detail in the following with reference to drawings and preferred embodiments in regard to the specific embodiments, steps, features and the effects thereof.

A first crosslinkable rubber composition according to the present invention comprises the following components: 40-70 phr of styrene butadiene copolymers, 10-30 phr of flow modifiers, 10-50 phr of softening oil, and 0.1-1 phr of vulcanizing agents.

A second crosslinkable rubber composition according to the present invention comprises the following components: 40-70 phr of styrene butadiene copolymers, 10-30 phr of flow modifiers, 10-50 phr of softening oil, 0.1-1 phr of vulcanizing agents, and 1-30 phr of auxiliary loading materials.

The above components will be described in detail as follows:

The styrene butadiene copolymer as described above, with or without the reclaimed materials, has a linear or multiple-arm star-shaped molecular structure, the molecular chain structure being a completely atactic copolymer structure of styrenic monomers and diene monomers or an alternating micro-block structure formed by the multiple block copolymerization of styrenic monomers and diene monomers, content of the 1,2-structure in the diene structure being 10-40%; the molecular structural formula of the styrene butadiene copolymer is —(PS_{X}—PB_{Y})ₙ— or (—(PS_{X}—PB_{Y})ₙ)_{M}R, with the former being of a linear structure while the latter of a multiple-arm star-shaped structure, where PS is a styrenic polymer, PB a diene polymer, R the “core” of the star-shaped structure, X a positive integer in the range of 1-300, Y a positive integer in the range of 1-2000, n a positive integer in the range of 10-3000, and M a positive integer in the range of 3-20; weight percent content of the styrenic monomer in this styrene butadiene copolymer is 5-80%, with molecular weight of the copolymer being 40000-500000 Da.

The flow modifier as described above, with or without the reclaimed materials, can be selected from at least one of styrene-butadiene-styrene copolymer, styrene-ethylene-butene-styrene copolymer, styrene-ethylene-propylene-styrene copolymer and combinations thereof.

The softening oil for rubber as described above, with or without the reclaimed materials, can be selected from naphthenic oil, alkane oil, aromatic hydrocarbon oil and combinations thereof.

The vulcanizing agent as described above, with or without the reclaimed materials, can be selected from one of the following groups consisting of benzoyl peroxide, bis(para-benzoyl peroxide), di-tert-butyl peroxide, dicumyl peroxide, cumene hydroperoxide and combinations thereof. Dicumyl peroxide is preferred.

The auxiliary loading material as described above, with or without the reclaimed materials, is preferably a reclaimed material, such as reclaimed rubber, reclaimed PE material, reclaimed EVA material, reclaimed PP material and combinations thereof. The auxiliary loading material can also be a natural or synthetic rubber, low density polyethylene (PE), ethylene-vinyl acetate copolymer (EVA), polypropylene (PP) and combinations thereof.

Moreover, according to intended uses, the crosslinkable rubber composition of the present invention can include known auxiliary assistances that do not exert a disadvantageous influence on the purposes of the present invention.

The auxiliary assistants, such as a vulcanization accelerator, an aging inhibitor, a mold releasing agent, an intensifier for rubber, an anti-ultraviolet agent, a flame retardant, a thickening agent, a detackifier, a crosslinking assistant, a colorant, a dispersant, an antioxidant, a conductive material and so on, are known in rubber industry. These auxiliary assistants are used at a normal dosage, which is especially dependent on the expected use. The normal dosage is, for example, 0.1 wt % to 50 wt % as required by the rubber.

The auxiliary assistant may be added to the rubber composition comprising the following components: 40-70 phr of styrene butadiene copolymers, 10-30 phr of flow modifiers, 10-50 phr of softening oil, and 0.1-1 phr of vulcanizing agents. This rubber composition may include an auxiliary assistant and further include reclaimed materials.

The intensifier for rubber is used for intensifying the mechanical properties of the crosslinked rubber, such as tensile strength, tear strength and abrasion resistance. The examples of the intensifier for rubber include such carbon black as SRF, GPF, FEF, HAF, ISAF, SAF, FT and MT, the carbon black that receives surface treatment with the silane coupling agent, fine powders of silicic acid, and silicon dioxide. The examples of the silicon dioxide include pyrolytic silicon dioxide and precipitated silicon dioxide.

The crosslinkable rubber composition according to the present invention can be used for manufacturing household rubber products, industrial rubber products and medical rubber products.

Exemplary household rubber products may be raincoats, shoes or gloves.

Exemplary industrial rubber products may be a rubber vibration isolator for automobiles, a rubber vibration isolator for railroads, a rubber vibration isolator for industrial devices, or an earthquake resisting rubber for buildings. Exemplary rubber vibration isolators for automobiles may be an engine mounting pad, a pulley absorber, a carburetor mounting pad, a torsional vibration damper, a strut mounting pad, a rubber bush, a snubber rubber, an auxiliary rubber, a spring piece, a shock damper, an air spring, an automobile body mounting pad, a bumper guard, a muffler support, a rubber coupling, a rubber clutch pad, a muffler mounting pad, a sliding bush, a cushion for strut bar, a rubber vibration isolator for a brake, a rubber vibration isolator for a handbrake, a heat radiator support and a muffler hanger. Exemplary rubber vibration isolators for railroads may be a pavement pad, a ballast pad or a rail pad. The rubber vibration isolator for industrial devices includes for example an expansion joint, a flexible joint, a sleeve or a mounting pad.

Exemplary industrial rubber products may be an automobile sealing strip, e.g. a car door sealing strip, a back door sealing strip, a trunk sealing strip, a side sealing strip on top, a sliding door sealing strip, a duct sealing strip, a sliding circular panel sealing strip, a front window sealing strip, a rear window sealing strip, a quarter window sealing strip, a pillar sealing strip, an outside door glass sealing strip, an inside door glass sealing strip, sealing strip for a windshield, a glass sliding track, an outside rear view mirror support, sealing strip for a closed headlight and sealing strip for a closed front upper panel.

Exemplary industrial rubber products may be rubber hoses, which include liquid hoses and gas hoses.

Exemplary medical rubber products may be syringe tubes, hoses, and infusion tubes.

The crosslinkable rubber grains according to the present invention are made of the rubber composition as described above, are suitable for injection molding or extrusion molding, and will not crosslink at a temperature below 140° C.

Compared with prior technology, the rubber grains have a number of advantages, such as direct formation through injection molding, not inclining to self-vulcanization, an easily controlled vulcanization rate, and no need for low temperature storage.

The present invention is also directed to a method for preparing the rubber grain using the rubber composition described herein. The method includes the following steps: first the styrene butadiene copolymer, the flow modifier, the reclaimed material and the soft oil are simultaneously put into an internal mixer to be internally mixed for 10-30 minutes. Then the vulcanizing agent is added and mixed for 3-10 minutes. The temperature of the internal mixer is 60-120° C. The stock after internal mixing is mixed in an open mixer and tight-milled 2-20 times before being rolled and sheeted. Finally the stock is extruded and pelletized by an extruder at a temperature of 60-110° C., and subsequently goes through air circulation cutting or water circulation cutting to form the grains.

The method for preparing the rubber grain may alternatively involve first adding and mixing the flow modifier and the soft oil in an internal mixer to be mixed for 5-15 minutes. Then the styrene butadiene copolymer and the reclaimed material are added and mixed for 5-15 minutes. The vulcanizing agent is subsequently added and mixed for 3-6 minutes. The temperature of the internal mixer is 60-120° C. The stock after internal mixing is mixed in an open mixer and tight-milled 2-20 times before being rolled and sheeted. Finally the stock is extruded and pelletized by an extruder at a temperature of 60-110° C., and subsequently goes through air circulation cutting or water circulation cutting to form the grains.

Yet another method for preparing the rubber grain may involve first simultaneously adding and mixing the styrene butadiene copolymer, the flow modifier, the reclaimed material and the soft oil in an internal mixer to be internally mixed for 10-30 minutes. The temperature of the internal mixer is 100-160° C. The stock formed after internal mixing is sheeted in an open mixer and a vulcanizing agent is added. The stock is then tight-milled 10-20 times before being rolled and sheeted. Finally the stock is extruded and pelletized by an extruder at a temperature of 60-110° C. and then goes through air circulation cutting or water circulation cutting to get the grains.

The present invention further discloses an injection molding method for making molded rubber products from the rubber grain.

In a first embodiment, the injection molding method involves heating the rubber grains. The rubber grains are pressurized to form a turbulent stock at a temperature of 50-120° C. and a pressure of 50-130 MPa. The turbulent stock is injected into a mold cavity, and the turbulent stock in this mold cavity is vulcanized at a temperature of 140-190° C. for no longer than 10 minutes, preferably 1-10 minutes.

In yet another embodiment, the injection molding method involves using three different kinds of rubber grains with different weight ratios relative to each other. The three rubber grains are heated and pressurized at a temperature of 50-120° C. and at a pressure of 50-130 MPa to form three kinds of turbulent stocks. The three kinds of turbulent stock are injected into three noncommunicating mold cavities, respectively. Preferably, early vulcanization is performed to vulcanize the turbulent stocks in these three noncommunicating mold cavities at a vulcanization temperature of 140-190° for 0-120 s. A middle moldboard among the three mold cavities is removed while the other two other moldboards positioned along both sides of the middle moldboard are buckled back, enabling two of the three mold cavities to communicate with the third mold cavity to form a single, integral, interconnected mold cavity. The turbulent stock in this complete mold cavity is vulcanized at a temperature of 140-190° C. for 100-360 s.

The injection molding methods as described above are designed for a single kind of rubber grain and for three different kinds of rubber grains, respectively. Person skilled in the art can further deduce a method of injection molding two kinds of rubber grains with different weight ratios. This injection molding method is similar to the second injection molding method, with the difference only in that there are two kinds of rubber grains and the corresponding mold has only two mold cavities.

The different weight ratios as described above can be different in the colorant, such as black rubber grains, blue rubber grains and red rubber grains. The color can also be other colors, such as yellow, green, white, purple and so on.

The second injection molding method as described above can be used to integrally mold products of different colors.

The crosslinkable rubber grains according to the present invention can be used for preparing the molded rubber products. The present invention is also directed to a molded rubber product that is prepared from the rubber grains by one of the above described injection molding methods. Further description of the invention is made with reference to the following examples.

### EXAMPLES

### Example 1

A first method for preparing the rubber grains is provided below. The rubber grains were prepared with the following components according to the following ratios (phr):

| | |
|---|---|
| Styrene butadiene copolymer | 70 phr |
| Styrene-ethylene-butene-styrene block copolymer | 10 phr |
| Naphthenic oil | 19.9 phr |
| Dicumyl peroxide | 0.1 phr |

The rubber grains were prepared according to the following steps. First the styrene butadiene copolymer, the styrene-ethylene-butene-styrene block copolymer and the naphthenic oil in the above ratio were simultaneously added and mixed in an internal mixer for 10 minutes. Then the dicumyl peroxide was added and mixed for 3 minutes, with the temperature of the internal mixer being 100° C. The stock formed after internal mixing was mixed in an open mixer and tight-milled 2 times before being rolled and sheeted. Finally the stock was extruded and palletized by an extruder at a temperature of 70° C., and underwent air circulation cutting to form the rubber grains of the first example.

### Example 2

A second method for preparing the rubber grains is provided below. The rubber grains were prepared with the following components according to the following ratios (phr):

| | |
|---|---|
| Styrene butadiene copolymer | 40 phr |
| Styrene-ethylene-butene-styrene block copolymer | 20 phr |
| Reclaimed rubber | 20 phr |
| Aromatic hydrocarbon oil | 19.5 phr |
| Dicumyl peroxide | 0.5 phr |

The rubber grains were prepared according to the following steps. First the styrene-ethylene-butene-styrene block copolymer and the aromatic hydrocarbon oil in the above ratio were put into an internal mixer and internally mixed for 5 minutes. Then the styrene butadiene copolymer and the reclaimed rubber were added and mixed for 10 minutes. Then the dicumyl peroxide was added and mixed for 5 minutes, with the temperature of the internal mixer being 80° C. The stock formed after internal mixing was mixed in an open mixer and tight-milled 5 times before being rolled and sheeted. Finally the stock was extruded and palletized by an extruder at a temperature of 60° C., and then underwent air circulation cutting to form the rubber grains of the second example.

### Example 3

A third method for preparing the rubber grains is provided below. The rubber grains were prepared with the following components according to the following ratios (phr):

| | |
|---|---|
| Styrene butadiene copolymer | 60 phr |
| Styrene-ethylene-butene-styrene block copolymer | 10 phr |
| Reclaimed PP | 10 phr |
| Naphthenic oil | 19 phr |
| Dicumyl peroxide | 1 phr |

The rubber grains were prepared according to the following steps. First the styrene butadiene copolymer, the styrene-ethylene-butene-styrene block copolymer, the reclaimed PP and the naphthenic oil in the above ratios are simultaneously put into an internal mixer and internally mixed for 20 minutes, with the temperature of the internal mixer being 160° C. Then the stock formed after internal mixing was sheeted in the open mixer and with the dicumyl peroxide added, tight-milled 30 times before being rolled and sheeted. Finally the stock was extruded and palletized by an extruder at a temperature of 110° C., and underwent water circulation cutting to form the rubber grains of the third example.

### Example 4

A fourth method for preparing the rubber grains is provided below. The rubber grains are prepared with the following components according to the following ratios (phr):

| | |
|---|---|
| Styrene butadiene copolymer | 55 phr |
| Styrene-ethylene-butene-styrene block copolymer | 15 phr |
| Naphthenic oil | 29.7 phr |
| Dicumyl peroxide | 0.3 phr |

The rubber grains are prepared according to the following steps. First the styrene butadiene copolymer, the styrene-ethylene-butene-styrene block copolymer and the naphthenic oil in the above ratio were simultaneously put into an internal mixer and internally mixed for 10 minutes. Then the dicumyl peroxide was added and mixed for 3 minutes, with the temperature of the internal mixer being 100° C. The stock formed after internal mixing was mixed in an open mixer and tight-milled 10 times before being rolled and sheeted. Finally the stock was extruded and palletized by an extruder at a temperature of 70° C. and then underwent air circulation cutting to form the rubber grains of the fourth example.

### Example 5

A fifth method for preparing the rubber grains is provided below. The rubber grains were prepared with the following components according to the following ratios (phr):

| | |
|---|---|
| Styrene butadiene copolymer | 40 phr |
| Styrene-ethylene-butene-styrene block copolymer | 9.5 phr |
| Naphthenic oil | 50 phr |
| Dicumyl peroxide | 0.5 phr |

There rubber grains were prepared according to the following steps. First the styrene butadiene copolymer, the styrene-ethylene-butene-styrene block copolymer and the naphthenic oil in the above ratio were simultaneously put into an internal mixer and internally mixed for 10 minutes. Then the dicumyl peroxide was added and mixed for 3 minutes, with the temperature of the internal mixer being 100° C. The stock after internal mixing was mixed in an open mixer, and tight-milled 10 times before being rolled and sheeted. Finally the stock was extruded and palletized by an extruder at a temperature of 70° C. and underwent air circulation cutting to get the rubber grains of the fifth example.

In the preparation processes for each example as described above, various processing assistants can be added as required by properties of different products, such as a vulcanization accelerator, an aging inhibitor, a mold releasing agent, a reinforcing agent, a flame retardant, a thickening agent and a detackifier.

### Example 6

The rubber grains prepared in each of the above examples were formed by injection molding with an injection molding machine to produce a sheet of rubber. The mold of the injection molding machine is provided with a heating arrangement, which can maintain the mold at a temperature of 100-200° C. The test data are as shown in Table 1.

TABLE 1
Properties of the rubber products
made of the rubber grains of the present invention

| | | Test result | | | | |
|---|---|---|---|---|---|---|
| | Test | Exam- | Exam- | Exam- | Exam- | Exam- |
| Test item | standard | ple 1 | ple 2 | ple 3 | ple 4 | ple 5 |
| Melt index | ASTM | 11.4 | 42.8 | 20.3 | 15.1 | 65 |
| (g/10 min) | D1238 | | | | | |
| Tensile | ASTM | 8.12 | 5.22 | 6.38 | 7.71 | 4.30 |
| strength | D638-98 | | | | | |
| (MPa) | | | | | | |
| Elongation at | ASTM | 1953 | 1338 | 827 | 1987 | 1620 |
| break | D638-98 | | | | | |
| (%) | | | | | | |
| Permanent | ASTM | 5.3 | 7.2 | 9.6 | 6.2 | 6.5 |
| compression | D935 | | | | | |
| deformation | | | | | | |
| (%) | | | | | | |

Note: Conditions for testing the melt index: 200° C. and 5 Kg, without a vulcanizing agent.

Conditions for preparing the sample: the injection temperature was 70° C. the vulcanization temperature was 165° C., and the vulcanization duration was 300 seconds.

It can be seen from the above test data that the melt indexes of all the rubber grains are over 10 g/10 min, indicating that fluidity of the grains fully fulfills the requirement of injection molding. All the materials have higher elongation at break, indicating that the rubber after vulcanization has good tenacity. All the materials have smaller permanent compression deformation, indicating that the rubber has better resilience, high flexibility and high tenacity, as well as sufficient strength, fully fulfilling the requirements of the rubber material.

The crosslinkable rubber grains according the present invention can be kept at a temperature of 35° C. over a long period of time, having no need for low-temperature storage.

### Example 7

The rubber grains of this experiment are prepared according to Example 3. A shoe sole was made by means of an injection molding method wherein rubber grains were heated and pressurized to form a turbulent stock at a temperature of 50-120° C. and at a pressure of 50-130 MPa. The turbulent stock was injected into the mold cavity, and the turbulent stock in the mold cavity was vulcanized at a temperature of 140-190° C. for a time period no longer than 10 minutes.

The properties of the shoe sole are shown in Table 2.

TABLE 2
Property test results of the shoe soles made of different materials

Material

| | | | PU | TR | | |
|---|---|---|---|---|---|---|
| Test item | | Example 7 | material | material | Rubber | Test standard |
| Density, g/cm³ | | 1.02 | 0.6 | 1.06 | 1.26 | SATRA 134: 1998 |
| Heat/scald resistance (300° C.) | | No | Severe | Severe | No | SATRA TM49: |
| | | damage | melt | melt | damage | 1995 |
| Slip resistance | Dry | 0.72 | 0.32 | 0.69 | 0.87 | SATRA TM144: |
| | Wet | 0.62 | 0.30 | 0.46 | 0.57 | 2006 |
| Abrasion, mm³ | | 93 | 148 | 401 | 332 | SATRA TM174: |
| | | | | | | 1994 |
| Flex resistance, (5000 cycles) | | No | No | No | No | SATRA TM218: |
| | | crack | crack | crack | crack | 1999 |
| Tear strength, | Lengthwise | 6.6 | 8.6 | 17.0 | 4.6 | SATRA TM218: |
| N/mm | Crosswise | 7.8 | 13.5 | 17.8 | | 1999 |
| Tensile strength, | Lengthwise | 9.8 | 10.0 | 5.5 | | |
| MPa | Crosswise | 8.2 | 7.7 | 5.4 | 4.8 | |
| Elongation at | Lengthwise | 628 | 468 | 592 | | SATRA TM137: |
| break, % | Crosswise | 704 | 316 | 668 | 512 | 1995 |

It can be seen from the above test data that the shoe sole made by injection molding of the rubber grains of the present invention, compared with the shoe sole made of conventional materials, has higher elongation at break, tear strength and tensile strength, as well as good slip resistance and heat/scald resistance. The rubber composition and rubber grains of the present invention therefore can fulfill the usage requirements.

What described above are preferred examples rather than restrictions on the present invention. Any simple amendment, alteration and equivalent structural change made on the above examples according to the technical substance of the present invention will all fall within the scope of protection of the technical solution of the present invention.

1. A crosslinkable rubber composition comprising:
40-70 phr of a styrene butadiene copolymer,
10-50 phr of a softening oil for rubber,
10-30 phr of a flow modifier, and
0.1-1 phr of a peroxide vulcanizing agent.

2. The crosslinkable rubber composition according to claim 1, further includes further comprising 1-30 phr of a reclaimed material selected from the group consisting of: reclaimed rubber, PE reclaimed materials, EVA reclaimed materials, PP reclaimed materials and combinations thereof.

3. The rubber composition according to claim 1, wherein the styrene butadiene copolymer has a molecular structure selected from the group consisting of: a linear molecular structure and a multiple-arm star-shaped molecular structure,
wherein the molecular structure is a completely atactic copolymer structure of styrenic monomers and diene monomers or an alternating micro-block structure formed by multiple block copolymerization of styrenic monomers and diene monomers;
wherein content of a 1,2-structure in the diene monomers is 10-40% and wherein a weight percent content of the styrenic monomer in the styrene butadiene copolymer is 5-80%;
wherein a molecular formula of the styrene butadiene copolymer having the linear molecular structure is —(PS_{X}—PB_{Y})ₙ— and wherein the molecular formula of the styrene butadiene copolymer having the multiple-arm star-shaped molecular structure is (—(PS_{X}—PB_{Y})ₙ)_{M}R, wherein —PS is a styrenic polymer, PB is a diene polymer, R is a core of the star-shaped structure, X is a positive integer in the range of 1-300, Y is a positive integer in the range of 1-2000, n is a positive integer in the range of 10-3000, and M is a positive integer in the range of 3-20; and,
wherein the styrene butadiene copolymer has a molecular weight of 40,000-500,000 Da.

4. The crosslinkable rubber composition according to claim 1, wherein the flow modifier is selected from the group consisting of: styrene-butadiene-styrene copolymer, styrene-ethylene-butene-styrene copolymer, styrene-ethylene-propylene-styrene copolymer and combinations thereof.

5. The crosslinkable rubber composition according to claim 1, wherein the softening oil for rubber is selected from the group consisting of: naphthene oil, alkane oil, aromatic hydrocarbon oil and combinations thereof.

6. The crosslinkable rubber composition according to claim 1, wherein the vulcanizing agent is selected from the group consisting of: benzoyl peroxide, bis(para-benzoyl peroxide), di-tert-butyl peroxide, dicumyl peroxide and cumene hydroperoxide.

7. The crosslinkable rubber composition according to claim 1, further comprising an auxiliary assistant selected from the group consisting of: a vulcanization accelerator, an aging inhibitor, a mold releasing agent, a reinforcing agent, a flame retardant, a thickening agent, a detackifier and combinations thereof.

8. (canceled)

9. A rubber product, wherein the rubber product is made from a crosslinkable rubber composition comprising:
40-70 phr of a styrene butadiene copolymer,
10-50 phr of a softening oil for rubber,
10-30 phr of a flow modifier, and
0.1-1 phr of a peroxide vulcanizing agent.

10. The rubber product according to claim 9, wherein the rubber product is selected from the group consisting of: raincoats, shoes, gloves, a rubber vibration isolator for automobiles, a rubber vibration isolator for railroads, a rubber vibration isolator for industrial devices, an earthquake resisting rubber for buildings and a medical apparatus.

11. (canceled)

12. The rubber product according to claim 10, wherein the rubber product is the rubber vibration isolator for automobiles selected from the group consisting of: an engine mounting pad, a liquid seal engine bearing mounting pad, a pulley absorber, a chain wheel absorber, a carburetor mounting pad, a torsional vibration damper, a strut mounting pad, a rubber bush, a snubber rubber, an auxiliary rubber, a spring piece, a shock damper, an air spring, an automobile body mounting pad, a bumper guard, a muffler support, a rubber coupling, a central bearing support, a rubber clutch pad, a muffler mounting pad, a suspension bush,a sliding bush, a cushion for strut bar, a rubber vibration isolator for a brake, a rubber vibration isolator for a handbrake, a heat radiator support, and a muffler hanger.

13. The rubber product according to claim 10, wherein the rubber product is the rubber vibration isolator for railroads and is selected from the group consisting of a pavement pad, a ballast pad and a rail pad.

14. The rubber product according to claim 10,
wherein the rubber product is the rubber vibration isolator for industrial devices and is selected from the group consisting of: an expansion joint, a flexible joint, a sleeve and a mounting pad.

15. The rubber product according to claim 9,
wherein the rubber product is an automobile sealing strip.

16. The rubber product according to claim 15, wherein the automobile sealing strip is selected from the group consisting of: a car door sealing strip, a back door sealing strip, a trunk sealing strip, a side sealing strip on top, a sliding door sealing strip, a duct sealing strip, a sliding circular panel sealing strip, a front window sealing strip, a rear window sealing strip, a quarter window sealing strip, a pillar sealing strip, an outside door glass sealing strip, an inside door glass sealing strip, sealing strip for a windshield, a glass sliding track, an outside rear view mirror support, sealing strip for a closed headlight and sealing strip for a closed front upper panel.

17. (canceled)

18. The crosslinkable rubber composition according to claim 1, wherein the rubber composition fauns a crosslinkable rubber grain.

19-20. (canceled)

21. The crosslinkable rubber composition according to claim 18, wherein the crosslinkable rubber grain is prepared by a method comprising the steps of:
simultaneously mixing the styrene butadiene copolymer, the flow modifier, a reclaimed material and the softening oil in an internal mixer for 10-30 minutes;
then adding the vulcanizing agent to the internal mixer and continuing mixing for 3-10 minutes at a temperature of 60-120° C. to form a stock;
transferring the stock to and mixing the stock in an open mixer
tight-milling the stock 2-20 times;
rolling and sheeting the tight-milled stock;
extruding and pelletizing the rolled and sheeted stock using an extruder at a temperature of 60-110° C.; and
forming the crosslinkable rubber grains by air circulation cutting or water circulation cutting the extruded and pelletized stock.

22. The crosslinkable rubber composition according to claim 18, wherein the crosslinkable rubber grain is prepared by a method comprising the steps of:
first mixing the flow modifier and the softening oil in an internal mixer for 5-15 minutes;
second, adding the styrene butadiene copolymer and a reclaimed material to the internal mixer and continuing mixing for 5-15 minutes;
third, adding the vulcanizing agent to the internal mixer and continuing internal mixing for 3-6 minutes at a temperature of 60-120° C. to form a stock;
transferring the stock to and mixing the stock in an open mixer;
tight-milling the stock 2-20 times;
rolling and sheeting the tight-milled stock;
extruding and pelletizing the rolled and sheeted stock using an extruder at a temperature of 60-110° C; and
forming the crosslinkable rubber grains by air circulation cutting or water circulation cutting the extruded and pelletized stock.

23. The crosslinkable rubber composition according to claim 18, wherein the crosslinkable rubber grain is prepared by a method comprising the steps of:
simultaneously mixing the styrene butadiene copolymer, the flow modifier, a reclaimed material and the softening oil in the internal mixer for 10-30 minutes at a temperature of 100-160° C. to form a stock;
sheeting the stock after mixing;
adding the vulcanizing agent to the sheeted stock;
tight-milling the stock with the vulcanizing agent 10-20 times;
rolling and sheeting the tight-milled stock;
extruding and pelletizing the rolled and sheeted stock using an extruder at a temperature of 60-110° C; and
forming crosslinkable rubber grains by air circulation cutting or water circulation cutting the extruded and pelletized stock.

24. A method for forming molded rubber products by injection molding the crosslinkable rubber grain according to claim 18, comprising the steps of:
heating the crosslinkable rubber grains;
pressurizing the heated crosslinkable rubber grains at a temperature of 50-120° C. and at a pressure of 50-130 MPa to form a turbulent stock;
injecting the turbulent stock into a mold cavity; and
vulcanizing the turbulent stock in the mold cavity at a temperature of 140-190° C. for 1-10 minutes.

25. The method of claim 24,
wherein the heating step comprises separately heating three kinds of rubber grains;
wherein the pressurizing step comprises pressurizing the three heated rubber grains having different ratios relative to each other into three separate turbulent stocks;
wherein the injecting step comprises injecting the three turbulent stocks into three noncommunicating mold cavities, respectively and
removing a middle moldboard among the three mold cavities while two other moldboards positioned at both sides of the middle moldboard are buckled back, enabling two of the three mold cavities to communicate with a third mold cavity to form an integral, interconnected mold cavity; and
wherein the vulcanizing step comprises vulcanizing the turbulent stock in the mold cavities at a temperature of 140-190° C. and a for 100-360 s.

26-29. (canceled)
